(19) United States
(12) Patent Application Publication
(10) Pub. No.: US 2020/0104275 A1
(43) Pub. Date: Apr. 2, 2020

(54) SHARED MEMORY SPACE AMONG DEVICES

(71) Applicant: Intel Corporation, Santa Clara, CA (US)

(72) Inventors: Sujoy SEN, Beaverton, OR (US); Susanne M. BALLE, Hudson, NH (US); Narayan RANGANATHAN, Bangalore (IN); Bradley A. BURRES, Waltham, MA (US)

(21) Appl. No.: 16/701,026

(22) Filed: Dec. 2, 2019

(51) Int. Cl. G06F 15/173; G06F 9/54

(52) U.S. Cl. CPC G06F 15/17331; G06F 9/541

(57) ABSTRACT

Some examples provide a manner of a memory transaction requester to configure a target to recognize a memory address as a non-local or non-shared address. An intermediary between the requester and the target configures a control plane layer of the target to recognize that a memory transaction involving the memory address is to be performed using a direct memory access operation. The intermediary is connected to the requester as a local device or process. After configuration, a memory transaction provided to the target with the configured memory address causes the target to invoke use of the associated direct memory access operation to retrieve content associated with the memory address or write content using a direct memory access operation.

### BACKGROUND

In data centers, some operations (e.g., workloads) are performed on behalf of customers by use of an accelerator device capable of performing a set of operations faster than a general purpose processor and also meet performance goals (e.g., a target latency, a target number of operations per second, etc.) of a service level agreement (SLA) with the customer. Transfer of data to and from the accelerator device can introduce latency and increase a time taken to complete a workload. In addition, copying content among memory or storage devices that do not share a memory domain can introduce challenges to accessing content.

### BRIEF DESCRIPTION OF THE DRAWINGS

FIG. 1A depicts a system with a computing platform with access to one or more computing platforms.

FIG. 1B provides an example of a remote direct memory access (RDMA) operation from one memory region to another memory region.

FIG. 2A depicts an example format of conversion between a memory address and direct memory access address at a requester side.

FIG. 2B also depicts an example conversion between host buffer address and a direct read queue identifier and/or direct write queue identifier.

FIG. 3A depicts an example sequence of operations to permit copying of content.

FIG. 3B depicts an example manner of an accelerator writing results to a requester or communicating with a requester.

FIG. 3C depicts an example sequence of operations to permit copying of content.

FIG. 3D depicts an example manner of an accelerator writing results to a requester or communicating with a requester.

FIG. 4A depicts an example process that can be performed by a requester.

FIG. 4B depicts an example process that can be performed by a target.

FIG. 4C depicts an example process that can be used by a target to provide results from processing based on a direct read operation.

FIG. 5 depicts an example system.

FIG. 6 depicts an environment.

### DETAILED DESCRIPTION

In an example physical memory domain, entities that are part of this domain can share data but use address translations (e.g., using pointers and address translation). A memory domain (e.g., physical, virtual, or logical) may span across servers assuming an interconnect which supports memory mapped constructs is used. Some interconnects and fabrics such as Intel compute express link (CXL), Peripheral Component Interconnect Express (PCIe), and Gen-Z provide memory based semantics using standing memory read or write commands and allow devices to share a memory address domain. However, some networking and fabric protocols, such as Ethernet and NVMe-oF, provide separate memory domains between a host and remote devices and a memory address domain is not shared between host and remote devices.

When an application (or other software or a device) uses a remote accelerator, there are buffers for input/output (IO) and the buffers are used by the application to provide work assignments and associated content to process as well as a place to receive results. For example, Ethernet uses messages (e.g., transmission control protocol (TCP), user datagram protocol (UDP), or remote direct memory access (RDMA)) for communications between applications (or other software or a device) and remote devices. The application actively manages data or command movement in a message to a destination. For example, an application instructs a remote accelerator of availability of a buffer and requests copying of content of the buffer. More specifically, data or command movement can involve allocation of a buffer, invoking direct memory access (DMA) or remote direct memory access (RDMA) to copy the data or command, holding onto the buffer while the accelerator device copies content of buffer, and the application scheduling performance of the command. However, active management of transfer of a data or command by an application can burden the core or resources used by the application.

Various embodiments provide for a requester (e.g., application, software or device) to offload memory transaction management to an interface when interacting with a target. In some embodiments, the interface can associate memory transactions with remote direct memory access semantics. For example, remote direct memory access semantics permit a requester to write or read to a remote memory over a connection including one or more of: an interconnect, network, bus, or fabric. In some examples, remote direct memory access semantics can use queue pairs (QP) associated with remote direct memory access (RDMA) as described at least in iWARP, InfiniBand, RDMA over converged Ethernet (RoCE) v2. The interface can be another device or software (or combination thereof). Independent from the requester, the interface can establish an RDMA queue pair configuration for various memory buffers with local or remote memory devices. In at least one embodiment, the requester may not have the capability to monitor where the target is situated or how it is accessed (e.g., local versus remote). Memory spaces or domains can be unshared between the requester and the target.

Various embodiments provide a requester capability to access to an accelerator-over-fabric (AOF) or endpoint device and the AOF or endpoint device configures a remote target to use a remote direct memory access protocol (e.g., RDMA) to read or write content from a local memory buffer to the requester.

For example, when a requester requests a memory transaction involving a target, the requester sends a request to a requester interface and specifies an address [address A]. The requester interface can provide a direct write or read queue having [address B] to associate with [address A] to a target's interface and the requester does not schedule performance of the memory transaction or request memory translation. The requester interface handles scheduling of performance of memory transactions. In some examples, the requester interface can coalesce (or combine) memory transactions and provide one or multiple addresses with translations to the memory device.

If the requester updates content of its buffer and requests work to be performed, the requester informs the requester interface as though the requester interface is a target accelerator device or processor. The requester interface copies data from the buffer to a memory space accessible to the target. The requester could continue to use the buffer and, independently, the requester and target interface can access data or other content when needed. In other words, the requester commands the requester interface as though commanding the target accelerator but the target accelerator can be connected through a connection to the requester interface. In this manner, the requester interface is transparent to the requester, and the requester interacts with the requester interface as though it were the target, communicating all commands to the requester interface that normally are directed to the target.

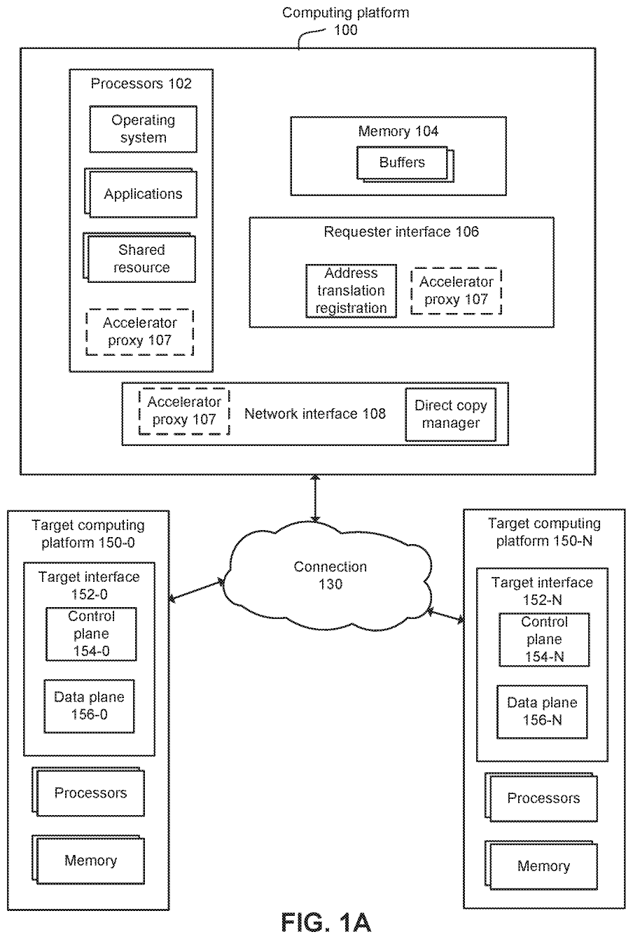

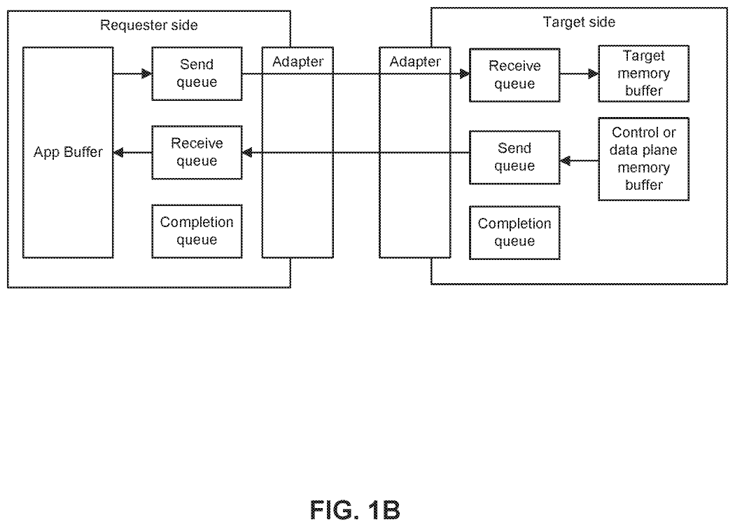

FIG. 1A depicts a system with a computing platform 100 with access to one or more target computing platforms 150-0 to 150-N, where N≥1. Computing platform 100 can include or access processors 102 and memory 104 to execute applications or virtualized execution environments. A virtualized execution environment can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux and Windows Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. The isolated nature of containers provides several benefits. First, the software in a container will run the same in different environments. For example, a container that includes PHP and MySQL can run identically on both a Linux computer and a Windows machine. Second, containers provide added security since the software will not affect the host operating system. While an installed application may alter system settings and modify resources, such as the Windows registry, a container can only modify settings within the container.

In some examples, processors 102 can include any central processing unit (CPU), graphics processing unit (GPU), field programmable gate array (FPGA), or application specific integrated circuit (ASIC). In some examples, processors 102 access requester interface 106 to configure one or more local buffers in memory 104 to permit direct memory access (read-from or write-to) involving any of target computing platforms 150-0 to 150-N. A target computing platform 150 can refer to any or all of computing platforms 150-0 to 150-N.

A target computing platform 150 can include or use one or more of: a memory pool, storage pool, accelerator, processor-executed software, neural engine, any device, as well as other examples provided herein, and so forth. In some examples, target computing platforms 150-0 to 150-N may not share memory space with computing platform 100 such that a memory access to a memory address specified by computing platform 100 would not allow any of computing platforms 150-0 to 150-N access the content intended to be accessed by computing platform 100. By contrast, a shared memory space among computing platform 100 and any of computing platforms 150-0 to 150-N could allow any of computing platforms 150-0 to 150-N to access content of the memory transparently (even with virtual or logical address translation to physical address). Accessing content of the memory transparently can include access to content specified by a memory address by use of a remote direct access protocol (e.g., RDMA) read or write operation.

Requester interface 106 can associate a memory region provided by processors 102 (or other device) with a direct write queue and/or direct read queue of a direct memory access operation. In some examples, a direct memory access operation can be an RDMA write or read operation and a direct write queue and/or direct read queue can be part of an RDMA queue pair between computing platform 100 and any of computing platform 150-0 to N.

In some examples, processors 102 can interact with requester interface 106 as though requesting a memory read or write by requester interface 106 and as though requester interface 106 is a local target device. Requester interface 106 can be implemented as any of a combination of a software framework and/or a hardware device. For example, accelerator proxy 107 represents a software framework for requester interface 106 and can be executed by one or more of requester interface 106, processors 102, or network interface 108.

For example, when requester interface 106 is implemented as a software framework (e.g., accelerator proxy 107), requester interface can be accessible through one or more application program interfaces (APIs) or an interface (e.g., PCIe, CXL, AMBA, NV-Link, any memory interface standard (e.g., DDR4 or DDR5), and so forth). Requester interface 106 can be a middleware or a driver that intercepts one or more APIs used to communicate with a local or remote accelerator device.

In some examples, requester interface 106 includes a physical hardware device that is communicatively coupled to processors 102. Requester interface 106 can be local to processors 102 and be connected via the same motherboard, rack, using conductive leads, datacenter, or using a connection. For example, any interface such as PCIe, CXL, AMBA, NV-Link, any memory interface standard (e.g., DDR4 or DDR5) and so forth can be used to couple requester interface 106 to processors 102. For example, requester interface 106 is presented to the requester as one or more PCIe endpoint(s), CXL endpoint(s), and can emulate different device and interact with hardware. A requester (e.g., software executed by processors 102 or any device) can program or receive responses from requester interface 106 using model specific registers (MSRs), control/status register (CSR), any register, or queues in device or memory that are monitored using, e.g., MONITOR/MWAIT.

Note that in some examples, if processors 102 are to invoke use of a target local to requester interface 106 or a target that can access buffers in memory 104, requester interface 106 can interact with such target and not configure a remote target interface 152. For example, if the target is local or a target that can access buffers in memory 104 even with address translation, requester interface 106 can provide any command or address to such target. Examples of targets are described herein and can include any processor, memory, storage, accelerator, and so forth.

In some examples, processors 102 can identify an application buffer to requester interface 106. Requester interface 106 can configure any target interface 152-0 to 152-N to identify a memory address associated with the application buffer as using a direct read or direct write operation. For example, a direct read operation or direct write operation can allow a remote device to write-to or read-from memory without management of a write or read by an operating system. Target interface 152 can refer to any or all of interfaces 152-0 to 152-N. Requester interface 106 can configure a control plane 154 of a particular target interface 152 using connection 130 to associate the memory address with a direct write queue and/or direct read queue of a direct memory access operation. Control plane 154 of a target interface 152 can configure a data plane 156 to recognize that writing-to or reading-from a particular memory address is to involve use of a particular direct write queue and/or direct read queue. In other words, when data plane 156 receives a configuration of a particular memory address with a particular direct write queue and/or direct read queue, data plane 156 will invoke use of a remote direct memory access operation involving the particular direct write queue and/or direct read queue to access content starting at the memory address.

After configuration of a target interface 152, in response to receipt of a command and arguments of buffer address(es) using a direct read access operation to a memory region accessible to a target computing platform 150, target computing platform 150 can initiate a direct read operation from the memory region using an associated direct read queue or a direct write operation to the memory region using an associated direct write queue.

Connection 130 can be provide communications compatible or compliant with one or more of: Ethernet (IEEE 802.3), remote direct memory access (RDMA), InfiniB and, Internet Wide Area RDMA Protocol (iWARP), quick UDP Internet Connections (QUIC), RDMA over Converged Ethernet (RoCE), Peripheral Component Interconnect (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

For example, target computing platform 150 can provide processors that provide capabilities described herein. For example, processors can provide compression (DC) capability, cryptography services such as public key encryption (PKE), cipher, hash/authentication capabilities, decryption, or other capabilities or services. In some embodiments, in addition or alternatively, target computing platform 150 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Target computing platform 150 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Target computing platform 150 can include a memory pool or storage pool, or computational memory pool or storage pool or memory used by a processor (e.g., accelerator). A computational memory or storage pool can perform computation local to stored data and provide results of the computation to a requester or another device or process. For example, target computing platform 150 can provide near or in-memory computing.

Target computing platform 150 can provide results to computing platform 100 from processing or a communication using a direct write operation. For example, a buffer in which results are written-to can be specified in a configuration of an application buffer with a direct read and/or write.

FIG. 1B provides an example of a remote direct memory access (RDMA) operation from one memory region to another memory region. Direct write or read allows for copying content of buffers across a connection without the operating system managing the copies. A network interface card or other interface to a connection can implement a direct memory access engine and create a channel from its RDMA engine though a bus to application memory.

The send queue and receive queue are used to transfer work requests and are referred to as a Queue Pair (QP). A requester (not shown) places work request instructions on its work queues that tells the interface contents of what buffers to send to or receive content from. A work request can include an identifier (e.g., pointer or memory address of a buffer). For example, a work request placed on the send queue can include an identifier of a message or content in a buffer (e.g., app buffer) to be sent. By contrast, an identifier in a work request in the receive queue can include a pointer to a buffer (e.g., app buffer) where content of an incoming message can be stored. A Completion Queue (CQ) can be used to notify when the instructions placed on the work queues have been completed.

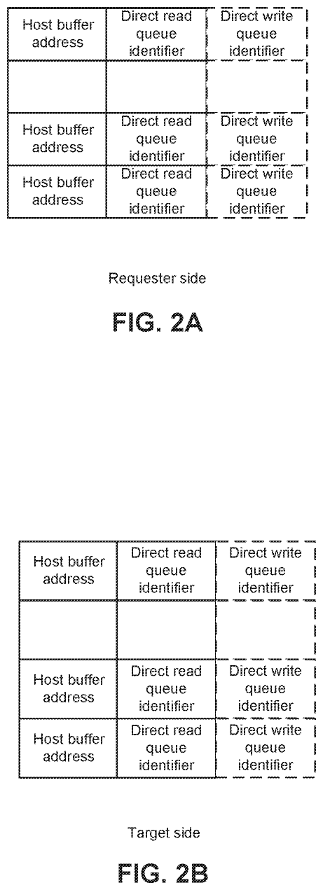

FIG. 2A depicts an example format of conversion between a memory address and direct memory access address at a requester side. For example, a host buffer address has a corresponding direct read queue identifier. A host buffer address may correspond to one or more direct read queue identifiers and/or multiple host buffer addresses may correspond to one direct read queue identifier. The direct read queue can correspond to an RDMA send queue identifier for example. In some examples, a host buffer address has a corresponding direct write queue identifier. A host buffer address may correspond to one or more direct write queue identifiers and/or multiple host buffer addresses may correspond to one direct write queue identifier.

FIG. 2B also depicts an example conversion between host buffer address and a direct read queue identifier and/or direct write queue identifier after configuration of a target interface. A target interface's data plane can use the conversion table to determine whether to convert a host buffer address to a remote direct access operation and if so, which read queue identifier and/or direct write queue identifier to use.

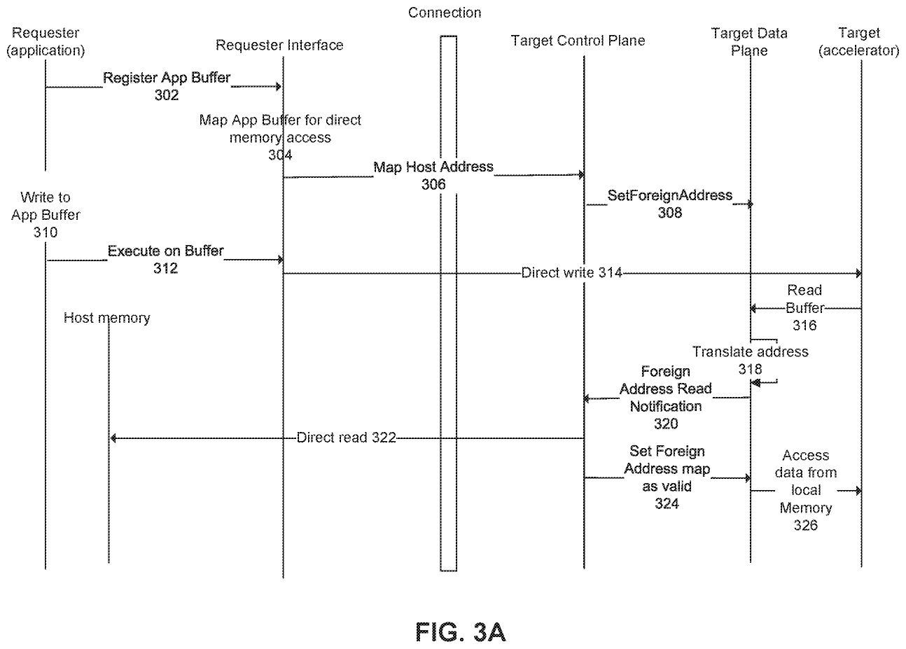

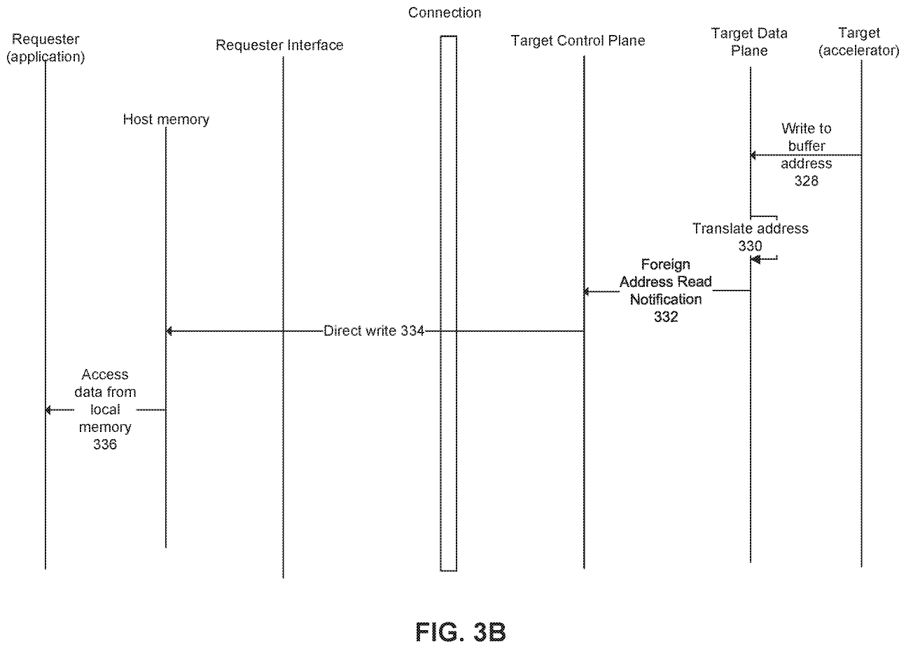

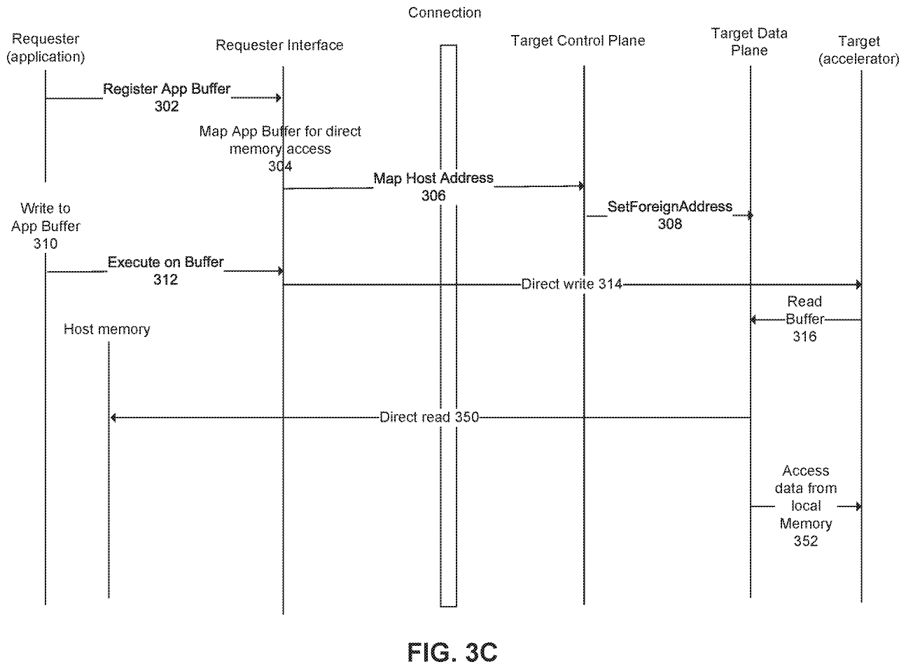

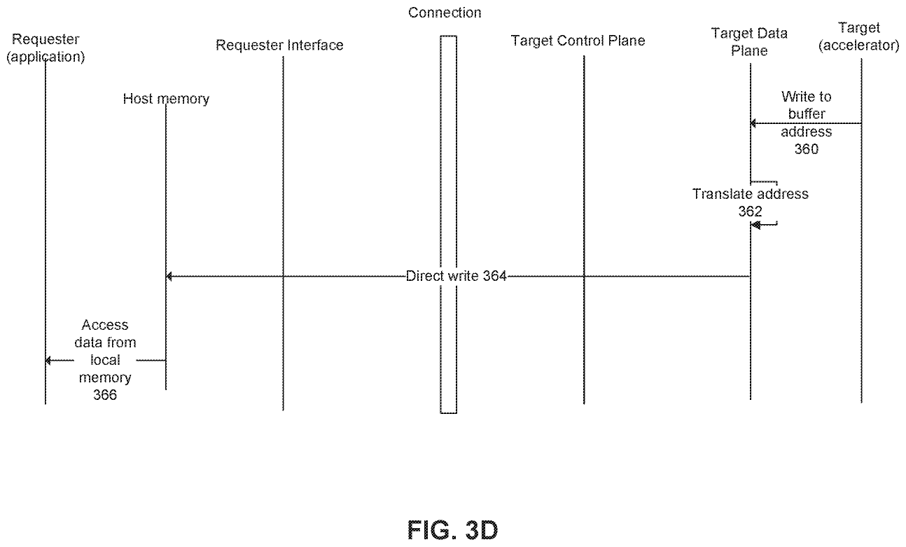

FIG. 3A depicts an example sequence of operations in which a requester requests an operation using a requester interface and the requester interface configures a target that does not share memory space with the requester to perform a copy operation using direct write or read operations. Configuration of a requester interface and target interface can occur in 302-308. At 302, a requester can register its app (application) buffer for use in activities by a target. The requester can be any one or more of: application, operating system, driver, virtual machine, container, any shared resource environment, accelerator device, compute platform, network interface, and so forth. Registering an app buffer can include a requester identifying a data buffer or region of memory to a requester interface. The requester interface can be embodied as any or a combination of an accelerator over fabric software framework or an end point device (e.g., smart end point (SEP)). Registering an app buffer can include specification of a starting address of the app buffer in a memory accessible to the requester and length of the app buffer that will be used to store data, instructions, or any content or be used to receive and store any content from another process or device. The starting address can be a logical, physical, or virtual address and in some cases, the starting address can be used without translation or in some cases the starting address is to be translated to identify a physical address. For example, a translation lookaside buffer (TLB) or memory management unit (MMU) can be used to translate an address.

Requester interface can be software running on a processor of a platform and a local to the requester. For example, requester interface can be accessible through one or more application program interfaces (APIs) or an interface (e.g., PCIe, CCIX, CXL, AMBA, NV-Link, any memory interface standard (e.g., DDR4 or DDR5), and so forth). Requester interface can be a middleware or a driver that intercepts one or more APIs used to communicate with a local or remote accelerator device. In other words, a requester can communicate with requester interface as though communicating with a local or remote accelerator using one or more APIs. A requester interface can perform a translation function to translate memory buffer addresses to RDMA send or receive queues. In some cases, the requester interface can intercept framework level API calls intended for a local or remote accelerator. In some cases, when requester interface is embodied as software, adjustment of a software stack (e.g., device drivers or operating system) to permit interoperability with different accelerator frameworks (e.g., Tensorflow, OpenCL, OneAPI) may be needed. In some example, operating system APIs can be used as the requester interface, or a portion thereof. In some examples, the requester interface can be registered as an exception handler for use in using RDMA connections to read or write connect associated with addresses provided to the requester interface.

In some examples, the requester interface includes a physical hardware device that is communicatively coupled to the requester. The requester can interact with the requester interface such that the requester interface appears as a local device to the requester. In other words, the request provides a memory address and/or command to the requester interface for the requester interface to use to access content at the memory address and/or perform the command even though the memory address and/or command are transmitted to a remote target using a connection and content of the memory address is accessed using a remote direct memory access protocol. The requester interface can be local to the requester and be connected via the same motherboard, rack, using conductive leads, datacenter, or using a connection. For example, any connection such as PCIe, CCIX, CXL, AMBA, NV-Link, any memory interface standard (e.g., DDR4 or DDR5 or other JEDEC or non-JEDEC memory standard) and so forth can be used. For example, the requester interface is accessible to the requester as one or more PCIe endpoint(s), CXL endpoint(s), and can emulate different device and interact with hardware. The requester can program or receives responses from the requester interface using MSRs, CSRs, any register, or queues in device or memory that are monitored such as using MONITOR/MWAIT. In some examples, a software stack used for accessing the embodiment of the requester interface as a physical hardware device need not be tailored to use the requester interface and can treat the requester interface as any device.

The requester interface can, in addition to other operations, act as a proxy for one or more local and/or remote targets (e.g., accelerators, graphics processing unit (GPU), field programmable gate array (FPGA), application specific integrated circuit (ASIC), or other inference engine). Using a single hardware device as a requester interface for multiple accelerators can reduce an amount of footprint allocated to availability of multiple accelerators. The requester interface can be embodied as a smart end point (SEP) device. An SEP device can be a device that is programmable and accessible using an interface as an endpoint (e.g., PCIe endpoint(s), CXL endpoint(s), and can emulate one or more devices and interact with such devices. The requester may not have awareness that the requester interface interacts with a remote interface or remote accelerator. In some examples, the requester commands the target as though the target shares memory address space with the requester using a non-memory coherent and non-memory-based connection. Memory coherence can involve a memory access to a memory being synched with the other entities' access to provide uniform data access. A memory-based connection allows transactions to be based on memory addresses (e.g., CXL, PCIe, or Gen-Z).

In some cases, the requester interface also provides accelerator features and functionality but can also be used to pass requests to other local or remote accelerator devices to carry out operations. Examples of accelerator features and functionality can include any type of computing, inference, machine learning, or storage or memory pools. Non-limiting examples of accelerators are described herein. A local accelerator can be connected to the requester through a motherboard, conductive leads, or any connection.

At 304, the requester interface maps an app buffer with a direct access operation. For example, mapping an app buffer with a direct access operation can include: mapping registered application buffer as part of an RDMA queue pair so that a remote accelerator can directly read or write from it using RDMA. Note that when RDMA is used for a direct access operation, a queue pair (QP) may have been previously established between a remote accelerator and local buffer in conjunction with an interface to a connection used by the requester. For example, for an RDMA enabled interface, the application buffer can be registered as accessible memory region via a particular RDMA queue pair. The requester need not oversee copying data from a buffer to an accelerator device buffer as a direct write or read operation is managed by the requester interface in conjunction with the target interface and any connection interfaces therebetween.

At 306, the requester interface configures a target control plane processor of a target interface to map a host address corresponding to a start address of the app buffer to a direct memory access buffer at the requester. For example, when the direct memory access uses RDMA, the mapping of host address corresponding to a start address of the app buffer to a send or receive buffer of a queue pair at the requester can be performed by sending the mapping to a receive queue used by the target. The target control plane processor is thereafter configured to associate a direct memory access operation with the start address.

At 308, the target control plane processor configures a target data plane of a target interface to identify the provided start address from the requester interface as using a direct write queue or read queue and corresponding operation. For example, SetForeignAddress can configure the data plane to associate the provided start address with a remote memory transaction. Note that the target control plane and data plane can be embodied in a single or separate multiple physical devices and the control plane can configure operation of the data plane. The target control and data plane can be separate or part of the network interface or interface to the connection. For example, configuration of the app buffer for use to copy content from requester to target accelerator can also specify a buffer address and direct write send or receive queue used by an accelerator to provide results or other content to the requester. After configuration of a target data plane, by providing a host memory address to the requester interface, the requester can cause direct memory access operations (e.g., reads or writes). Target data plane can be implemented as an SEP or other hardware device and/or software that is accessed as a local device to an accelerator.

After configuration of a requester interface and target interface, at 310, the requester writes content to an app buffer in memory. Content can be for example, any of an image file, video file, numbers, data, database, spreadsheet, neural network weights, and so forth. At 312, the requester informs the requester interface to apply a target specific command (e.g., perform particular operation on content, classify or recognize content of image, run convolutional neural network (CNN) on input, and so forth) on content in the app buffer. At 314, the requester interface uses a direct write operation to send the command to a remote accelerator and includes arguments of buffer address(es). For example, an RDMA write operation can be used at 314 to convey the command and at least associated buffer address(es) to a memory accessible to the target.

In response to the received direct write command, at 316, the accelerator issues a buffer read to a target data plane and provides the buffer address(es) to the target data plane. Based on address translation configuration, at 318, target data plane translates buffer address(es) to a direct memory transaction send or receive queue associated with the buffer address(es).

In some examples, target data plane does not have direct access to a connection with the requester and uses a control plane to access the connection. A data plane may not have capability to initiate a direct write or read operation but the control plane can initiate a direct write or read operation. At 320, target data plane requests the control plane to perform a direct read operation from the app buffer to copy content of the app buffer to a memory accessible to the data plane. For example, a direct read operation can use an RDMA read operation to copy contents of a buffer associated with a send queue to a memory region used by a data plane. At 324, after successful copying of contents of the app buffer to the memory region used by a data plane, the control plane indicates that access to content of the buffer address(es). The control plane can identify the buffer address(es) as valid to the data plane and provide an address and length of the memory region used by a data plane to the accelerator. At 326, the target retrieves content from the memory region used by a data plane and copies the content to local device memory accessible by the target. In some cases, the target may access the content directly from the memory region used by a data plane.

Subsequently, the target can return result(s) to the requester or communicate with the requester. For example, FIG. 3B depicts an example manner of an accelerator writing results to a requester or communicating with a requester. In this example, the target data plane does not have direct access to a connection with the requester and uses a control plane to access the connection. At 328, the accelerator provides to a target data plane a write to buffer request with a specified address. At 330, the target data plane translates the memory location to a direct write buffer and, at 332, informs the target control plane of the direct write buffer. At 334, a direct write of a result or other information or instructions occurs. An RDMA write operation can be used to write content to a receive queue accessible to the requester, where the receive queue can correspond to an app buffer. At 336, a requester can access data or other content from memory that was received from the target.

FIG. 3C depicts an example sequence of operations in which a requester requests an operation using a requester interface and the requester interface configures an accelerator that does not share memory space with the requester to perform a copy operation using direct write or read operations. Configuration of a requester interface and target interface can occur in substantially the same manner as described with respect to 302-308 of FIG. 3A. Requests to read a buffer can take place in accordance with 310-316 of FIG. 3A. In some examples, target data plane of target interface has direct access to a connection with the requester and can issue direct read or write commands to memory accessible to the requester. A data plane may have capability to initiate a direct write or read operation using a network interface. At 350, target data plane of target interface can initiate copy of data or content from the app buffer allocated to the requester to a memory accessible to target data plane. For example, a direct read command can be an RDMA read operation based on a receive queue associated with an app buffer. At 352, the accelerator can access content from the memory accessible to target data plane.

Subsequently, in the scenario of FIG. 3C, the accelerator can return result(s) to the requester or communicate with the requester using a process described with respect to FIG. 3D, however the process described with respect to FIG. 3B could be used. FIG. 3D depicts an example manner of an accelerator writing results to a requester or communicating with a requester. In this example, the target data plane has direct access to a connection to communicate with the requester. At 360, the accelerator provides to a target data plane a write to buffer request with a specified address. The specified address can indicate a memory location at the requester in which to write a result or other information or instructions. At 362, based on address translation configuration, target data plane translates buffer address(es) to a direct receive queue associated with the buffer address(es). At 364, the target data plane via a network interface accesses the connection and performs a direct write operation to the app buffer to copy content of memory region accessible to the accelerator to the app buffer. For example, a direct write operation can use an RDMA write operation to copy contents to a buffer associated with a receive queue associated with the requester. At 366, the requester can access content from the buffer.

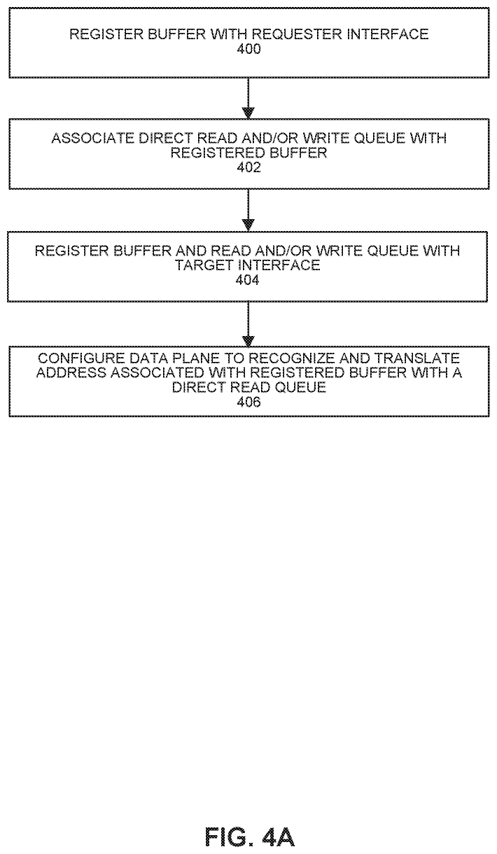

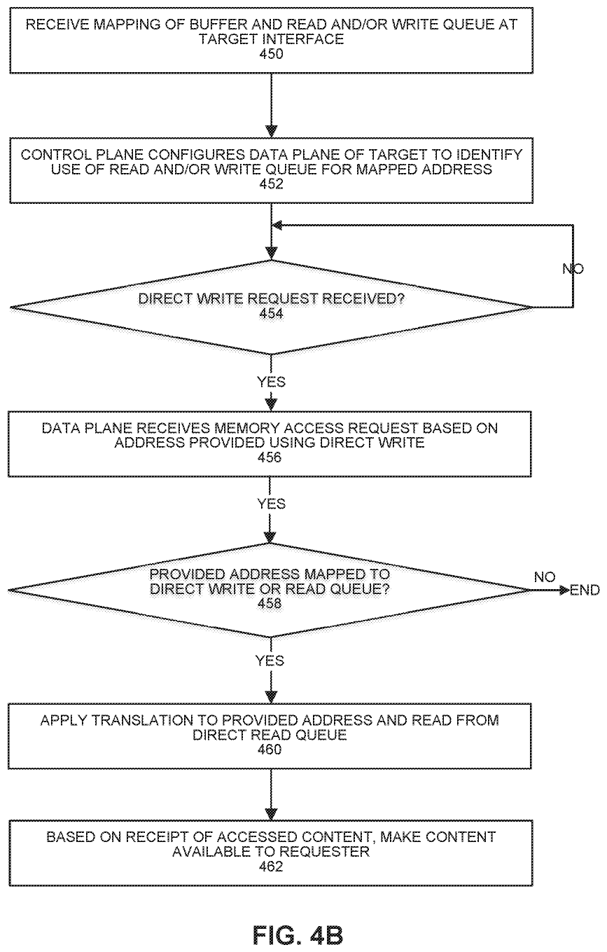

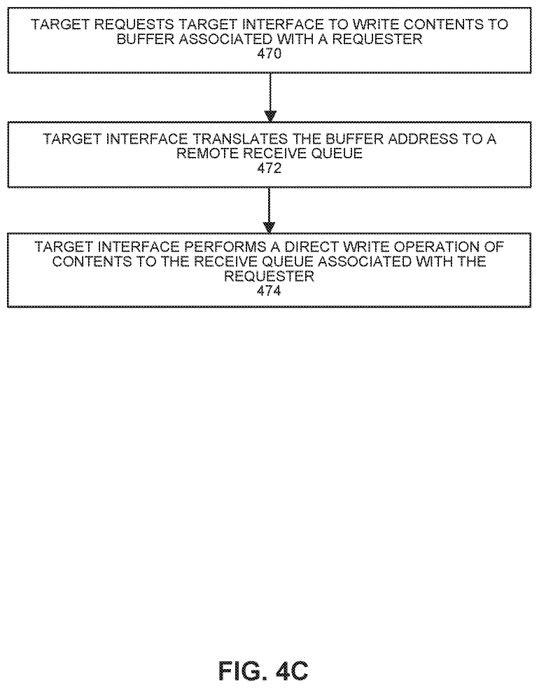

FIG. 4A depicts an example process that can be performed by a requester. The process can be performed to initialize a target to associate a host address with a direct read operation. At 400, a buffer is registered with a requester interface. In some examples, a requester registers the buffer with a requester interface. The requester can be any application, shared resource environment, virtual machine, container, driver, operating system, or any device. The buffer can be associated with a starting memory address and a length including and/or after the starting memory address. The starting memory address and length can define a size of a buffer. The buffer can be used to store content to be copied to a local or remote accelerator and/or receive content generated or caused to be copied by a local or remote accelerator.

At 402, a direct read queue is associated with the registered buffer from which to copy content for copying to a memory accessible to a local or remote target. In some examples, a direct read buffer is a send queue as part of an RDMA queue pair with an accelerator and the send queue is used to direct copy content of the direct read buffer to a memory used by the target. In some examples, a completion or return queue is also identified and associated with a buffer that can be directly written-to. A direct write queue can be associated with the registered buffer to receive content transmitted at the request of a local or remote target. In some examples, a direct write buffer is a receive queue as part of an RDMA queue pair with a target and the receive queue is used to direct copy content of the direct write buffer to a memory used by the requester.

At 404, the pair of a memory address associated with the buffer and the direct read and/or write buffer are registered with a target interface. The registering can include using a direct memory copy operation to provide the pair to a memory accessible to a memory region accessible to a control plane associated with the target interface. In addition, a direct write operation can be associated with the buffer.

At 406, the control plane can configure a data plane associated with the target interface to translate any request from a target with a memory address to use a direct read operation involving a particular read queue. In addition, the control plane can configure the data plane to convert a request for a write to the buffer to use a direct write operation associated with the buffer.

FIG. 4B depicts an example process that can be performed by a target. A target can include a target interface that uses a control plane controller and a data plane. The requester's partner can communicate with the requester using a connection. For example, a target can provide compression (DC) capability, cryptography services such as public key encryption (PKE), cipher, hash/authentication capabilities, decryption, or other capabilities or services. For example, target can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Target can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

At 450, a requester interface maps an address associated with an app buffer to a direct read queue using a control plane controller of the target. In some examples, in addition, or alternatively, the address (or an offset from the address) and a length are associated with the app buffer is associated with a direct write queue using a control plane controller of the target occurs. A read and write queue can be part of an RDMA queue pair. The mapping can be received with a command to associate a host address with a direct read send-receive pair. In some examples, the command with association of host address with a send queue can be transmitted using a direct write operation to a write queue of a target that is accessible to the control plane controller.

At 452, a control plane configures a data plane to identify use of conversion of the mapped address to a read or write queue. For example, a control plane controller can configure a data plane using an association of a host address with a send or receive queue at a requester. After configuration of a data plane to associate a mapped address with a send or receive queue, the data plane can recognize a mapped address is associated with a direct send or receive queue and memory accesses can involve access to the send or receive queue.

At 454, a determination is made if a direct write request is received at a target. A direct write request can be a RDMA write operation to a receive queue that is part of a queue pair between the target and the requester. A direct write can send a command to the target that includes commands and arguments of buffer address(es). If a direct write is received, the process continues to 456. If a direct write is not received, 454 repeats.

At 456, the target requests a data plane to access the address provided with direct write. At 458, the data plane determines if the address is mapped to a direct write or read queue. If the address is mapped to a direct write or read queue, then 460 follows. If the address is not mapped to a direct write or read queue, then the process can end and a memory access can occur with or without memory translation (e.g., virtual or logical to physical address) to access memory local to the target.

At 460, translation is applied to the provided address to identify a direct read queue and a direct read operation takes place from the direct read queue. In some examples, if the data plane has access to a connection to communicate with host memory associated with the requester, the data plane causes a direct read operation to be performed from the read queue associated with the provided address. The data plane can issue RDMA read based on RDMA address for content starting at a host address to retrieve data.

In some examples, the data plane does not have direct access to a connection with the receiver and the data plane causes the control plane controller to perform a direct read based on the provided host address over the connection and using a network or fabric interface to the connection. For example, control plane controller can perform an RDMA read from a send queue associated with the host address and copy content into data plane memory.

At 462, based on receipt of the content at a memory, the data plane makes the content available in a local device memory accessible by the target. For example, the data plane can copy the content to another memory region or allow the target to access the content directly from the local device memory. In some cases, the target can retrieve data from data plane memory and copy content to a local device memory accessible by the target.

FIG. 4C depicts an example process that can be used by a target to provide results from processing based on a direct read operation. For example, a buffer in which results are written to can be specified in a direct write operation or during mapping of an app buffer to a direct read and/or write operation. At 470, a target requests a target interface to write contents (e.g., results, a command or communication) to a buffer associated with a requester. For example, the target can request a data plane of a target interface to write the content to the buffer. The target may not recognize that a buffer is remote to the target and can offload any address translation and transactions over a connection with a remote requester to a target interface (e.g., control and data planes).

At 472, the target interface translates the app buffer to a remote receive queue that can be used in a direct copy operation. For example, the remote receive queue can correspond to a receive queue of a RDMA queue pair. Configuration of the target interface to associate the remote receive queue with the app buffer with the remote receive queue can occur in a prior action (e.g., 402 of FIG. 4A).

At 474, the target interface performs a direct write operation of the contents to the receive queue associated with the requester. In some examples, the data plane of the target interface can access a connection with the requester's memory and can perform the direct write operation. In some examples, the data plane of the target interface cannot access a connection with the requester's memory, and the data plane uses the control plane of the target interface to access the access a connection with the requester's memory and can perform the direct write operation. Thereafter, the requester can access content from the buffer.

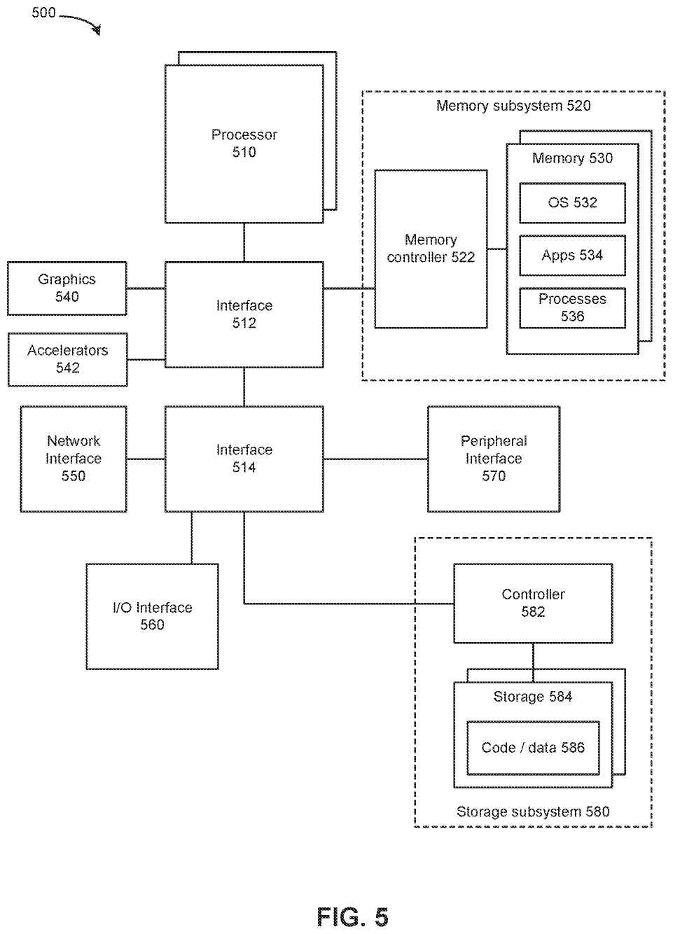

FIG. 5 depicts an example system. The system can use embodiments described herein to provide access to data or other content in a memory to one or more local or remote accelerators. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080 p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (i.e., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (i.e., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (i.e., buses) for coupling appropriate integrated circuits (ICs) and other components mounted to the board.

Various embodiments can be used in a base station that supports communications using wired or wireless protocols (e.g., 3GPP Long Term Evolution (LTE) (4G) or 3GPP 5G), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

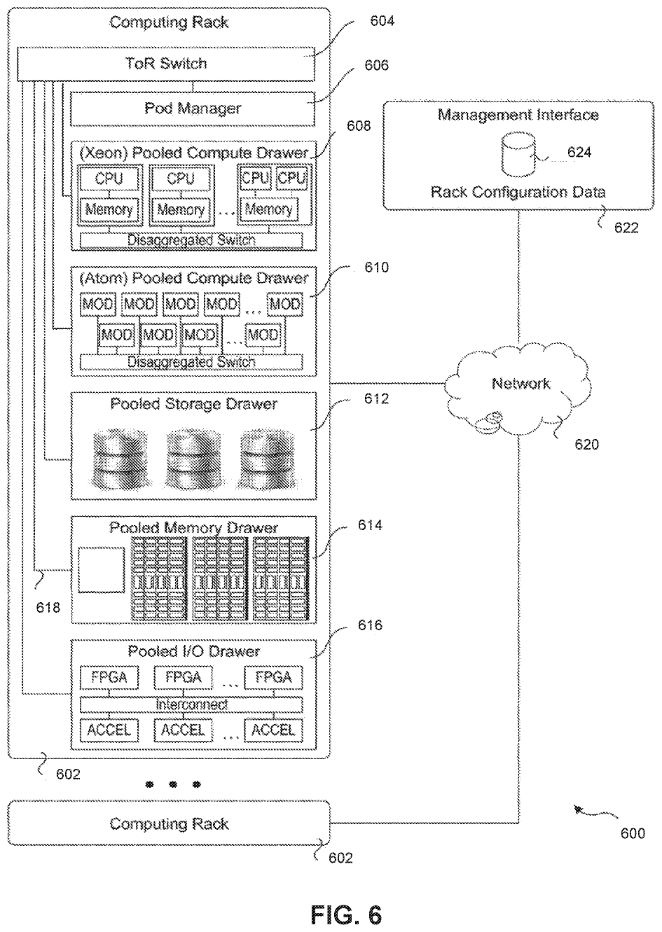

FIG. 6 depicts an environment 600 includes multiple computing racks 602, one or more including a Top of Rack (ToR) switch 604, a pod manager 606, and a plurality of pooled system drawers. Various embodiments can be used among racks to share content or data or results of processing or storing content. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 608, and Intel® ATOM™ pooled compute drawer 610, a pooled storage drawer 612, a pooled memory drawer 614, and a pooled I/O drawer 616. Any of the pooled system drawers is connected to ToR switch 604 via a high-speed link 618, such as a 40 Gigabit/second (Gb/s) or 100 Gb/s Ethernet link or a 100+ Gb/s Silicon Photonics (SiPh) optical link, or higher speeds.

Multiple of the computing racks 600 may be interconnected via their ToR switches 604 (e.g., to a pod-level switch or data center switch), as illustrated by connections to a network 620. In some embodiments, groups of computing racks 602 are managed as separate pods via pod manager(s) 606. In one embodiment, a single pod manager is used to manage all of the racks in the pod. Alternatively, distributed pod managers may be used for pod management operations.

Environment 600 further includes a management interface 622 that is used to manage various aspects of the environment. This includes managing rack configuration, with corresponding parameters stored as rack configuration data 624.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

An example includes a computer-readable medium comprising instructions stored thereon, that if executed by at least one processor, cause the at least one processor to: receive, from a requester interface, a mapping of a host address and a direct read queue; configure a data plane of a target interface to use the direct read queue to access the host address; based on receipt of a request to read the host address, cause access to the direct read queue; and based on receipt of content of the direct read queue, indicate the content is available for access by a target. According to any example, the direct read queue comprises a send queue of a remote direct memory access (RDMA) compatible queue-pair. Any example can include instructions stored thereon, that if executed by at least one processor, cause the at least one processor to: receive a request to write to a buffer address and based on the buffer address corresponding to a direct write queue, cause a direct write operation to the direct write queue. According to any example, the direct write queue comprises a receive queue of a remote direct memory access (RDMA) compatible queue-pair.

Example 1 includes a computer-readable medium with instructions stored thereon, that if executed by at least one processor, cause the at least one processor to: configure a remote target interface to apply a remote direct memory access protocol to access content associated with a local buffer address based on a memory access request that identifies the local buffer address and transfer a memory access request to the remote target interface that requests access to a local buffer address.

Example 2 includes any example, and includes instructions stored thereon, that if executed by at least one processor, cause the at least one processor to: configure a requester interface to associate a local buffer address with a direct read queue for access using a remote direct memory access operation.

Example 3 includes any example, wherein the requester interface comprises a software framework accessible through an application program interface (API).

Example 4 includes any example, wherein the direct read queue comprises a send queue of a remote direct memory access (RDMA) compatible queue pair.

Example 5 includes any example, and includes instructions stored thereon, that if executed by at least one processor, cause the at least one processor to: associate the local buffer address with a direct write queue for use in a remote direct memory access operation.

Example 6 includes any example, wherein the direct write queue comprises a receive queue of a remote direct memory access (RDMA) compatible queue pair.

Example 7 includes any example, and includes instructions stored thereon, that if executed by at least one processor, cause the at least one processor to: provide a command associated with the local buffer address to the remote target interface, wherein the command comprises a target specific command to perform one or more of: a computation using content of a buffer associated with the local buffer address, retrieve content of the buffer, store content in the buffer, or perform an inference using content of the buffer.

Example 8 includes any example, wherein a requester is to cause configuration of a remote target interface and the requester comprises one or more of: an application, shared resource environment, or a device.

Example 9 includes any example, wherein a target is connected to the remote target interface and the target does not share memory address space with the requester.

Example 10 includes a method that includes: configuring a device to associate a direct write queue or direct read queue with a memory address; based on receipt of a memory read operation specifying the memory address, applying a remote direct read operation from a direct read queue; and based on receipt of a memory write operation specifying the memory address, applying a remote direct write operation to a direct write queue.

Example 11 includes any example, wherein the remote direct read operation is compatible with remote direct memory access (RDMA) and the direct read queue comprises a send queue of a RDMA compatible queue-pair.

Example 12 includes any example, wherein the remote direct write operation is compatible with remote direct memory access (RDMA) and the direct write queue comprises a receive queue of a RDMA compatible queue-pair.

Example 13 includes any example, and includes receiving, at an interface, an identification of a buffer from a requester; based on the identification of a buffer to access, associating with the buffer, one or more of a direct write queue and a direct read queue; and in response to a request to access content of the buffer, configuring a remote target interface to use one or more of a direct write queue or a direct read queue to access content of the buffer.

Example 14 includes a computing platform that includes: at least one processor; at least one interface to a connection; and at least one requester interface, wherein: a processor, of the at least one processor, is to identify a buffer, by a memory address, to a requester interface, the requester interface is to associate a direct write queue or direct read queue with the buffer, and the requester interface is to configure a remote target interface to use a remote direct read or write operation when presented with a memory access request using the memory address of the buffer.

Example 15 includes any example, wherein the requester interface is a device locally connected to a requester.

Example 16 includes any example, wherein the processor of the at least one processor is to configure the remote target interface to associate the memory address of the buffer with the direct write queue.

Example 17 includes any example, wherein the connection is compatible with one or more of: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect Express (PCIe), Intel QuickPath Interconnect (QPI), Intel Ultra Path Interconnect (UPI), Intel On-Chip System Fabric (IOSF), Omnipath, Compute Express Link (CXL), HyperTransport, NVLink, Advanced Microcontroller Bus Architecture (AMB A) interconnect, OpenCAPI, Gen-Z, Cache Coherent Interconnect for Accelerators (CCIX), 3GPP Long Term Evolution (LTE) (4G), or 3GPP 5G.

Example 18 includes a computing platform that includes: at least one processor; at least one interface to a connection; and at least one accelerator, a second interface between the at least one accelerator and the at least one interface to a connection, wherein the second interface is to: receive a mapping of a host address and a direct read queue; configure a data plane to use the direct read queue and remote direct memory access semantics to access content associated with the host address; based on receipt of a request to read the host address, cause access to the direct read queue; and based on receipt of content associated with the direct read queue, indicate the content is available for access by an accelerator.

Example 19 includes any example, wherein the direct read queue comprises a send queue of a remote direct memory access (RDMA) compatible queue-pair.

Example 20 includes any example, wherein the second interface is to: receive a request to write to a buffer address and based on the buffer address corresponding to a direct write queue, cause a remote direct write operation to the direct write queue.

Example 21 includes any example, wherein the direct write queue comprises a receive queue of a remote direct memory access (RDMA) compatible queue-pair.

What is claimed is:

1. A computer-readable medium comprising instructions stored thereon, that if executed by at least one processor, cause the at least one processor to:
configure a remote target interface to apply a remote direct memory access protocol to access content associated with a local buffer address based on a memory access request that identifies the local buffer address and
transfer a memory access request to the remote target interface that requests access to a local buffer address.

2. The computer-readable medium of claim 1, comprising instructions stored thereon, that if executed by at least one processor, cause the at least one processor to:
configure a requester interface to associate a local buffer address with a direct read queue for access using a remote direct memory access operation.

3. The computer-readable medium of claim 2, wherein the requester interface comprises a software framework accessible through an application program interface (API).

4. The computer-readable medium of claim 2, wherein the direct read queue comprises a send queue of a remote direct memory access (RDMA) compatible queue pair.

5. The computer-readable medium of claim 2, comprising instructions stored thereon, that if executed by at least one processor, cause the at least one processor to:
associate the local buffer address with a direct write queue for use in a remote direct memory access operation.

6. The computer-readable medium of claim 5, wherein the direct write queue comprises a receive queue of a remote direct memory access (RDMA) compatible queue pair.

7. The computer-readable medium of claim 1, comprising instructions stored thereon, that if executed by at least one processor, cause the at least one processor to:
provide a command associated with the local buffer address to the remote target interface, wherein the command comprises a target specific command to perform one or more of: a computation using content of a buffer associated with the local buffer address, retrieve content of the buffer, store content in the buffer, or perform an inference using content of the buffer.

8. The computer-readable medium of claim 1, wherein a requester is to cause configuration of a remote target interface and the requester comprises one or more of: an application, shared resource environment, or a device.

9. The computer-readable medium of claim 8, wherein a target is connected to the remote target interface and the target does not share memory address space with the requester.

10. A method comprising:
configuring a device to associate a direct write queue or direct read queue with a memory address;
based on receipt of a memory read operation specifying the memory address, applying a remote direct read operation from a direct read queue; and
based on receipt of a memory write operation specifying the memory address, applying a remote direct write operation to a direct write queue.

11. The method of claim 10, wherein the remote direct read operation is compatible with remote direct memory access (RDMA) and the direct read queue comprises a send queue of a RDMA compatible queue-pair.

12. The method of claim 10, wherein the remote direct write operation is compatible with remote direct memory access (RDMA) and the direct write queue comprises a receive queue of a RDMA compatible queue-pair.

13. The method of claim 10, further comprising:
receiving, at an interface, an identification of a buffer from a requester;
based on the identification of a buffer to access, associating with the buffer, one or more of a direct write queue and a direct read queue; and
in response to a request to access content of the buffer, configuring a remote target interface to use one or more of a direct write queue or a direct read queue to access content of the buffer.

14. A computing platform comprising:
at least one processor;
at least one interface to a connection; and
at least one requester interface, wherein:
a processor, of the at least one processor, is to identify a buffer, by a memory address, to a requester interface,
the requester interface is to associate a direct write queue or direct read queue with the buffer, and
the requester interface is to configure a remote target interface to use a remote direct read or write operation when presented with a memory access request using the memory address of the buffer.

15. The computing platform of claim 14, wherein the requester interface is a device locally connected to a requester.

16. The computing platform of claim 14, wherein the processor of the at least one processor is to configure the remote target interface to associate the memory address of the buffer with the direct write queue.

17. The computing platform of claim 14, wherein the connection is compatible with one or more of: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect Express (PCIe), Intel QuickPath Interconnect (QPI), Intel Ultra Path Interconnect (UPI), Intel On-Chip System Fabric (IOSF), Omnipath, Compute Express Link (CXL), HyperTransport, NVLink, Advanced Microcontroller Bus Architecture (AMB A) interconnect, OpenCAPI, Gen-Z, Cache Coherent Interconnect for Accelerators (CCIX), 3GPP Long Term Evolution (LTE) (4G), or 3GPP 5G.

18. A computing platform comprising:
at least one processor;
at least one interface to a connection; and
at least one accelerator,
a second interface between the at least one accelerator and the at least one interface to a connection, wherein the second interface is to:
receive a mapping of a host address and a direct read queue;
configure a data plane to use the direct read queue and remote direct memory access semantics to access content associated with the host address;
based on receipt of a request to read the host address, cause access to the direct read queue; and
based on receipt of content associated with the direct read queue, indicate the content is available for access by an accelerator.

19. The computing platform of claim 18, wherein the direct read queue comprises a send queue of a remote direct memory access (RDMA) compatible queue-pair.

20. The computing platform of claim 18, wherein the second interface is to:
receive a request to write to a buffer address and
based on the buffer address corresponding to a direct write queue, cause a remote direct write operation to the direct write queue.

21. The computing platform of claim 18, wherein the direct write queue comprises a receive queue of a remote direct memory access (RDMA) compatible queue-pair.
